(19) United States
(12) Patent Application Publication
(10) Pub. No.: US 2012/0229771 A1
(43) Pub. Date: Sep. 13, 2012

(54) PROJECTOR AND IMAGE DISPLAY SYSTEM

(75) Inventors: Yoshinori HASHIMOTO, Shiojiri-shi (JP); Toshimitsu WATANABE, Matsumoto-shi (JP)

(73) Assignee: SEIKO EPSON CORPORATION, Tokyo (JP)

(21) Appl. No.: 13/397,177

(22) Filed: Feb. 15, 2012

(30) Foreign Application Priority Data
Mar. 10, 2011 (JP) 2011-052618

(51) Int. Cl. G02B 27/22; G03B 21/14

(52) U.S. Cl. 353/7; 353/101

(57) ABSTRACT

A projector modulates a light beam emitted from a light source in accordance with image information, and then projects a right-eye image and a left-eye image on a screen in a time-sharing manner. The projector includes a projection lens adapted to project the light modulated, a lens shift mechanism adapted to move the projection lens in a direction perpendicular to an optical axis, a transmitting device adapted to output an optical signal synchronous with switching between the right-eye image and the left-eye image toward the screen, and an interlocking mechanism adapted to move the transmitting device in conjunction with the lens shift mechanism.

### BACKGROUND

1. Technical Field

The present invention relates to a projector and an image display system.

2. Related Art

In the past, there has been known a projector which modulates a light beam emitted from a light source in accordance with image information, and then projects the light beam thus modulated on a screen. Further, in recent years, there has been proposed a technology for projecting a right-eye image and a left-eye image on a screen to thereby make the observer wearing special spectacles recognize them as a three-dimensional image (see, e.g., JP-A-2006-126501 (Document 1)).

The multi-view three-dimensional display device described in Document 1 is provided with a projector and an infrared light emitting device. The projector projects a predetermined picture on a screen in accordance with a video signal input thereto. The infrared light emitting device is connected to the projector and is disposed above the screen, and emits light to thereby output an infrared signal synchronous with the video signal. Then, the observer wearing the special spectacles (liquid crystal shutter glasses) recognizes the picture as a three-dimensional image due to the right and left shutters opened and closed in accordance with the infrared signal.

However, although not described in detail in Document 1, it is conceivable that the projector and the infrared light emitting device are connected to each other via a cable or the like, and there is a problem that it is cumbersome to install the multi-view three-dimensional display device because of, for example, handling of the cable. Therefore, it is possible to incorporate the infrared light emitting device in the projector, and make the infrared signal be reflected by the screen to thereby reach the special spectacles. However, if the infrared light emitting device is housed in the projector, there arises a problem that the projector grows in size. Further, in the projector provided with a lens shift mechanism for displacing the projection lens, since the projector is used while varying the relative position thereof to the screen, there is a problem that it is difficult to stably reflect the infrared signal with the screen.

### SUMMARY

An advantage of some aspects of the invention is to solve at least a part of the problem described above, and can be implemented as the following forms or application examples.

### Application Example 1

This application example of the invention is directed to a projector adapted to modulate a light beam, which is emitted from a light source, in accordance with image information, and project the light modulated on a screen with a projection lens, including a lens shift mechanism adapted to move the projection lens in a direction perpendicular to an optical axis of the projection lens, a transmitting device adapted to output an optical signal different from the light toward the screen, and an interlocking mechanism adapted to move the transmitting device in conjunction with movement of the projection lens due to the lens shift mechanism.

According to this configuration, even if the relative position to the screen is not limited, it becomes possible for the projector to project the image on the screen by the lens shift mechanism moving the projection lens. Further, since the transmitting device moves in conjunction with movement of the projection lens due to the interlocking mechanism, it becomes possible for the transmitting device to output the optical signal toward the screen even in the case in which the projection lens is moved. Therefore, it becomes possible to provide a projector, which has high flexibility of installation, reflects the optical signal with the screen even in the case in which the projection lens is moved, and makes the optical signal thus reflected be used.

### Application Example 2

In the projector of the above application example of the invention, it is preferable that the interlocking mechanism moves the transmitting device so that a location of the optical signal varies in conjunction with movement of an image projected on the screen due to the lens shift mechanism. According to this configuration, it becomes possible for the projector to reliably reflect the optical signal with the screen even in the case in which the image projected on the screen is moved. Therefore, it becomes possible to provide a projector, which has high flexibility of installation, and makes the optical signal reliably reflected by the screen be used.

### Application Example 3

In the projector of the above application example of the invention, it is preferable that the interlocking mechanism moves the transmitting device so that the optical signal output from the transmitting device is emitted within the image moved on the screen by the lens shift mechanism.

According to this configuration, it becomes possible for the projector to reliably reflect the optical signal within the image on the screen to thereby make the optical signal reach the observer observing the image projected even in the case in which the image projected on the screen is moved. Therefore, it becomes possible to provide a projector, which has high flexibility of installation, and makes the optical signal made to reach the observer be used.

### Application Example 4

In the projector of the above application example of the invention, it is preferable that the lens shift mechanism is configured to be able to move the projection lens in a predetermined direction in a plane perpendicular to the optical axis, and the interlocking mechanism moves the transmitting device so that the direction of the output of the optical signal is changed to the predetermined direction in conjunction with movement of the projection lens toward the predetermined direction.

According to this configuration, it becomes possible to move the optical signal with a small space compared to the configuration of moving the transmitting device in a sliding manner. Therefore, it becomes possible to realize a configuration of preventing the projector from growing in size and moving the transmitting device using the interlocking mechanism.

### Application Example 5

In the projector of the above application example of the invention, it is preferable that the lens shift mechanism is configured to be able to move the projection lens in two directions perpendicular to each other in a plane perpendicular to the optical axis, and the interlocking mechanism moves the transmitting device so that the direction of the optical signal output from the transmitting device is changed in conjunction with movement of the projection lens in one of the directions.

Here, the two directions perpendicular to each other in a plane perpendicular to the axis denote, for example, two directions of a vertical direction and a horizontal direction viewed from the observer observing the image. Ey configuring the projection lens movable in one direction in which the projection lens is thought to be used with high frequency, the flexibility of installation of the projector can be enhanced. Further, it becomes possible to configure the interlocking mechanism with a structure simpler than that of the interlocking mechanism interlocking in two directions.

### Application Example 6

In the projector of the above application example of the invention, it is preferable that the lens shift mechanism is configured to be able to move the projection lens in two directions perpendicular to each other in a plane perpendicular to the optical axis, and the interlocking mechanism moves the transmitting device so that the direction of the output of the optical signal is changed to the two directions in conjunction with movement of the projection lens toward the two directions, respectively.

According to this configuration, it becomes possible to further enhance the flexibility of installation of the projector, and output the optical signal toward the screen within the movable range of the projection lens.

### Application Example 7

In the projector of the above application example of the invention, it is preferable that the projector is configured to be able to project a first image and a second image on the screen in a time-sharing manner, and the optical signal is an optical signal synchronous with switching between the first image and the second image.

According to this configuration, it becomes possible to reflect the optical signal with the screen to thereby make the optical signal reach the observer who observes the image projected on the screen. Therefore, by easily installing the projector without performing a cumbersome operation, and wearing the image observing spectacles having the shutter switched in accordance with the optical signal received, it becomes possible for the observer to recognize the images projected on the screen as a three-dimensional image, or to observe them as two types of images.

### Application Example 8

In the projector of the above application example of the invention, it is preferable that the first image is a right-eye image and the second image is a left-eye image.

According to this configuration, since the first image is a right-eye image and the second image is a left-eye image, by wearing the image observing spectacles having a shutter switched in response to receiving the optical signal, it becomes possible for the observer observing the image projected on the screen to recognize the image projected on the screen as a three-dimensional image. Therefore, it becomes possible to provide a projector, which enhance the flexibility of installation, and performs the projection allowing recognition as a three-dimensional image.

### Application Example 9

This application example of the invention is directed to an image display system including the projector of anyone of the above application examples of the invention, and an image observing spectacles including a receiving section adapted to receive the optical signal output from the transmitting device and reflected by the screen, and a shutter switched in accordance with the optical signal received by the receiving section between an open state in which a light passes through the shutter and a light blocking state in which the light is blocked by the shutter.

According to this configuration, by easily installing the projector with respect to the screen and then observing the screen while wearing the image observing spectacles, the image observing spectacles surely receive the optical signal reflected by the screen, and the user of this system can recognize the image projected on the screen as an image such as a three-dimensional image.

### BRIEF DESCRIPTION OF THE DRAWINGS

The invention will be described with reference to the accompanying drawings, wherein like numbers reference like elements.

FIG. 1 is a perspective view schematically showing an external appearance of a projector according to a first embodiment of the invention.

FIG. 2 is a schematic diagram showing a schematic internal configuration of the projector according to the first embodiment.

FIGS. 3A and 3B are perspective views of a projection lens, a lens shift mechanism, a transmitting device, and an interlocking mechanism of the first embodiment.

FIG. 4 is a perspective view of the lens shift mechanism of the first embodiment.

FIG. 5 is a cross-sectional view showing the transmitting device and a part of the interlocking mechanism according to the first embodiment.

FIG. 6 is an exploded perspective view of the interlocking mechanism of the first embodiment.

FIG. 7 is a cross-sectional view showing a part of the interlocking mechanism located in the vicinity of a shift-side support section according to the first embodiment.

FIGS. 8A and 8B are diagrams showing the projection lens, a first moving section, the interlocking mechanism, and the transmitting device in a reference state of the first embodiment.

FIGS. 9A and 9B are diagrams of the projection lens, the first moving section, the interlocking mechanism, and the transmitting device of the first embodiment viewed from above.

FIGS. 10A and 103 are diagrams of the projection lens, the first moving section, the interlocking mechanism, and the transmitting device of the first embodiment viewed from a +X direction.

FIG. 11 is a perspective view schematically showing an external appearance of image observing spectacles according to the first embodiment.

FIGS. 12A and 12B are schematic diagrams of the image display system and the screen according to the first embodiment.

FIGS. 13A and 13B are perspective views of a front case, a transmitting device, and an interlocking mechanism according to a second embodiment of the invention.

### DESCRIPTION OF EXEMPLARY EMBODIMENTS

### First Embodiment

Hereinafter, a projector and an image display system according to a first embodiment will be explained with reference to the accompanying drawings.

The projector according to the present embodiment modulates a light beam, which is emitted from a light source, in accordance with image information, and then projects the light beam thus modulated on a screen in an enlarged manner. Further, the projector according to the present embodiment is capable of projecting a right-eye image as a first image and a left-eye image as a second image on the screen in a time-sharing manner, and has a configuration of outputting an optical signal synchronous with switching between the right-eye image and the left-eye image toward the screen. Then, if the observer who observes the image projected on the screen wears special image-observing spectacles, the image-observing spectacles are controlled by the optical signal reflected by the screen, and the observer can recognize the image thus projected as a three-dimensional image.

The image display system is configured including the projector and the image-observing spectacles.

### Principal Configuration of Projector

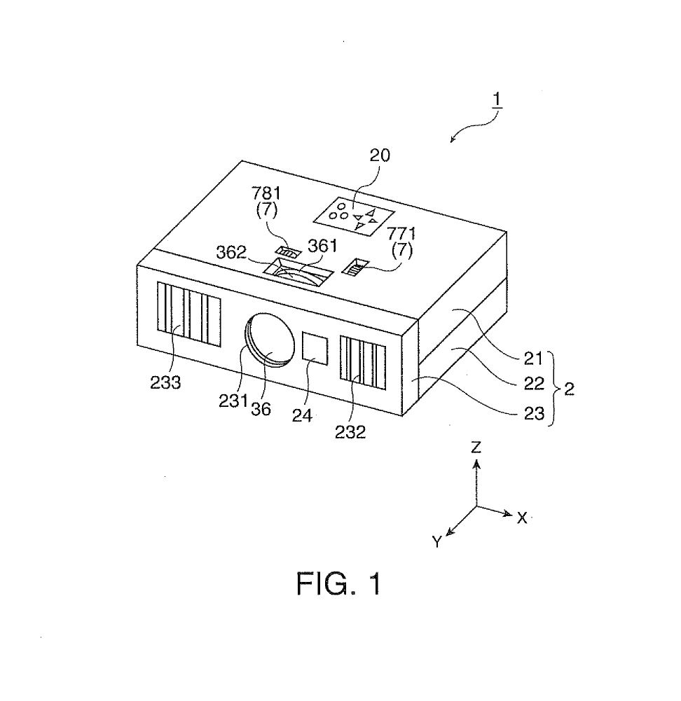

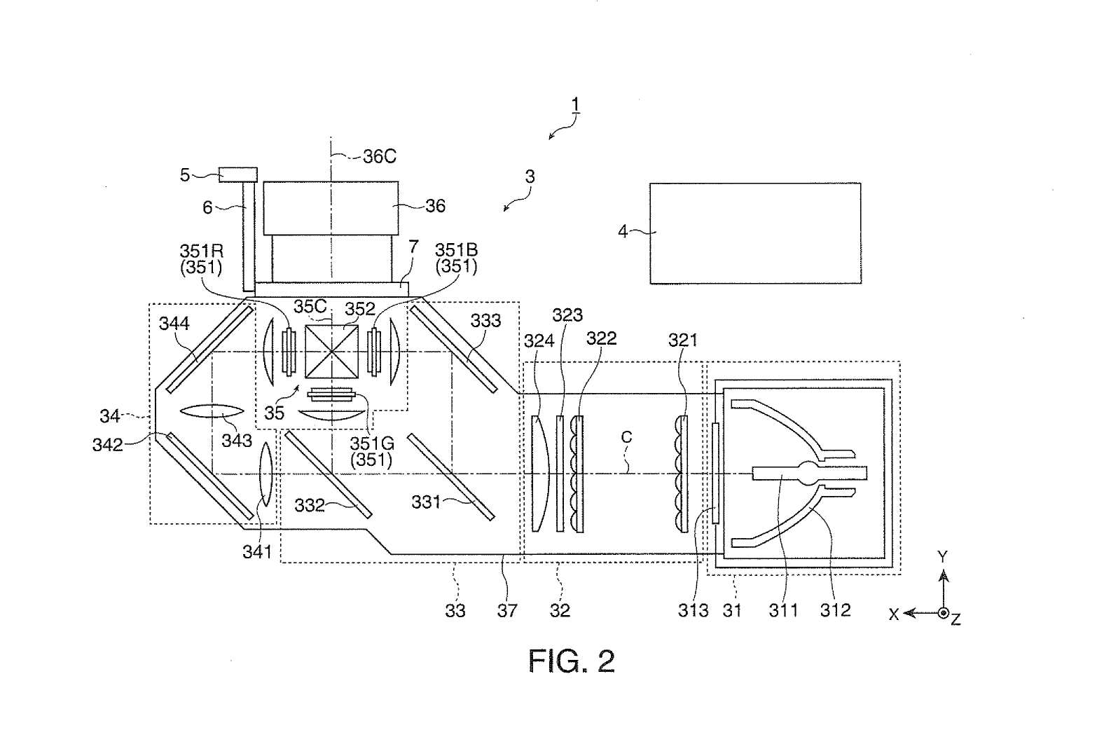

FIG. 1 is a perspective view schematically showing an external appearance of the projector 1 according to the present embodiment. FIG. 2 is a schematic diagram showing a schematic internal configuration of the projector 1.

As shown in FIGS. 1 and 2, the projector 1 is provided with an exterior housing 2 for constituting the exterior, a control section (not shown), an optical unit 3 including a light source device 31, a power supply device 4, a transmitting device 5, an interlocking mechanism 6, and so on.

It should be noted that although not shown specifically, constituents for cooling the inside of the projector 1 such as a fan and a duct for guiding air are disposed inside the exterior housing 2. Further, for the sake of convenience of explanation, the description will hereinafter be presented assuming that the direction in which a light beam is emitted from the light source device 31 is a +X direction, the direction in which the light to be projected is emitted from the projector 1 is a +Y direction (a front direction), and an upward direction in FIG. 1 is a +Z direction (an upward direction).

The exterior housing 2 is made of synthetic resin, and is provided with an upper case 21, a lower case 22, a front case 23, and so on as shown in FIG. 1, which are fixed with screws or the like.

As shown in FIG. 1, the upper case 21 constitutes an upper part of the exterior housing 2. On the upper surface of the upper case 21, there is disposed an operation panel 20 for performing a variety of instruction to the projector 1 in a rear part thereof, and in front of the operation panel 20, there is disposed an opening section through which a zoom lever 361 and a focus lever 362 provided to a projection lens 36 described later are exposed. Further, on the upper surface of the upper case 21, there is disposed an opening section in a rear part of the zoom lever 361 through which a first dial 771 and a second dial 781 of a lens shift mechanism 7 described later are exposed.

The lower case 22 constitutes a lower part of the exterior housing 2. Below the lower case 22, there are disposed legs (not shown) having contact with a mounting surface when the projector 1 is mounted on a desk or the like so as to protrude therefrom.

The front case 23 constitutes a front part of the exterior housing 2. As shown in FIG. 1, in the central area of the front case, there is formed an opening section (a projecting opening section 231) having a circular shape viewed from the front through which the light to be projected passes.

The front case 23 is provided with an air inlet 232 through which external air is taken in disposed on the +X side of the projecting opening section 231, and inside the air inlet 232, there is disposed an air intake duct not shown. Further, the front case 23 is provided with an air outlet 233 through which heated air inside the exterior housing 2 is discharged to the outside disposed on the −X side of the projecting opening section 231, and inside the air outlet 233, there is disposed an exhaust air duct not shown.

Further, the front case 23 is provided with an opening section having a rectangular planar shape disposed between the projecting opening section 231 and the air inlet 232, and the opening section is blocked by an optical filter 24. Further, behind the optical filter 24, there is disposed the transmitting device 5 for outputting the optical signal.

As the optical filter 24 there is adopted polycarbonate resin for transmitting the optical signal output from the transmitting device 5, and preventing the transmission of the visible light in the wavelength range different from that of the optical signal, and thus, it is arranged that the transmitting device 5 is difficult to be seen from the outside of the projector 1. It should be noted that the material of the optical filter 24 is not limited to polycarbonate resin, but other materials can also be used providing the material transmits the optical signal output from the transmitting device 5.

The control section is provided with a central processing unit (CPU), a read only memory (ROM), a random access memory (RAM), and so on to thereby function as a computer, and performs control of the operation of the projector 1.

The optical unit 3 optically processes the light beam emitted from a light source 311 and then projects it under control of a control section.

As shown in FIG. 2, the optical unit 3 is provided with a light source device 31, an integrator illumination optical system 32, a color separation optical system 33, a relay optical system 34, an electrooptic device 35, an optical component housing 37 for disposing these components 31 through 35 at predetermined positions on the light path, a projection lens 36, and the lens shift mechanism 7.

The optical unit 3 is formed to have roughly L-planar shape as shown in FIG. 2, and is provided with the light source device 31 detachably disposed on one end portion, and the projection lens 36 disposed on the other end portion.

The light source device 31 is provided with the light source 311 of a discharge type formed of, for example, a super-high pressure mercury lamp and a metal halide lamp, a reflector 312, a collimating lens 313 as a light transmissive member, and so on. The light source device 31 reflects the light beam emitted from the light source 311 with the reflector 312, and then aligns the emission direction using the collimating lens 313 to emit the light beam toward the integrator illumination optical system 32.

The integrator illumination optical system 32 is provided with a first lens array 321, a second lens array 322, a polarization conversion element 323, and an overlapping lens 324.

The first lens array 321 is an optical element for splitting the light beam emitted from the light source device 31 into a plurality of partial light beams, and is provided with a plurality of small lenses arranged in a matrix in a plane roughly perpendicular to a light axis C of the light beam emitted from the light source device 31.

The second lens array 322 has a configuration substantially the same as that of the first lens array 321, and overlaps the partial light beams emitted from the first lens array 321 on a surface of a liquid crystal light valve 351 described later together with the overlapping lens 324.

The polarization conversion element 323 has a function of aligning the random light emitted from the second lens array 322 into a substantially single polarized light available to the liquid crystal light valve 351.

The color separation optical system 33 is provided with two dichroic mirrors 331, 332, and a reflecting mirror 333, and has a function of separating the light beam emitted from the integrator illumination optical system 32 into three colored lights of red light (hereinafter referred to as “R light”), green light (hereinafter referred to as “G light”), and blue light (hereinafter referred to as “B light”).

The relay optical system 34 is provided with an entrance lens 341, a relay lens 343, and reflecting mirrors 342, 344, and has a function of guiding the R light separated into by the color separation optical system 33 to the liquid crystal light valve 351R for the R light. It should be noted that although it is assumed that the optical unit 3 has the configuration in which the relay optical system 34 guides the R light, the configuration is not limited thereto, but a configuration of guiding, for example, the B light can also be adopted.

The electrooptic device 35 is provided with the liquid crystal light valve 351 as a light modulation device and a cross dichroic prism 352 as a color combining optical device, and modulates the colored lights separated into by the color separation optical system 33 in accordance with the right-eye and left-eye image information, and then combines the colored lights thus modulated.

The liquid crystal light valve 351 is provided to each of the three colors of colored lights (hereinafter the liquid crystal light valve for the R light is denoted by 351R, the liquid crystal light valve for the G light is denoted by 351G, the liquid crystal light valve for the B light is denoted by 351B), and has a transmissive liquid crystal panel and an entrance polarization plate and an exit polarization plate respectively disposed on both surfaces of the liquid crystal panel.

The liquid crystal light valve 351 has a rectangular pixel area with fine pixels, not shown, formed in a matrix, and forms a display image in the pixel area with each of the pixels set to the optical transmittance corresponding to the image information. Further, each of the colored lights thus separated into by the color separation optical system 33 is modulated by the liquid crystal light valve 351, and is then emitted to the cross dichroic prism 352.

The cross dichroic prism 352 has a substantially rectangular planar shape composed of four rectangular prisms bonded to each other, and on the interfaces on which the rectangular prisms are bonded to each other, there are formed two dielectric multilayer films. In the cross dichroic prism 352, the dielectric multilayer films reflect the colored lights modulated by the liquid crystal light valves 351R, 351E while transmitting the colored light modulated by the liquid crystal light valve 351G to thereby combine the colored lights. Then, the light thus combined by the cross dichroic prism 352 is emitted to the projection lens 36 with a light axis 35C.

The projection lens 36 is configured including a plurality of lenses (not shown) arranged along an optical axis 36C, a zoom lever 361, a focus lever 362 (both shown in FIG. 1), and a flange section (not shown), and is attached to the lens shift mechanism 7. The projection lens 36 projects the light, which is modulated by the liquid crystal light valves 351 and then combined by the cross dichroic prism 352, on the screen in an enlarged manner. As a result, the left-eye image and the right-eye image are alternately projected on the screen frame by frame.

Further, in the projection lens 36, a lens making a contribution to zoom adjustment is moved by rotating the zoom lever 361 to thereby perform the zoom adjustment, and a lens making a contribution to focus adjustment is moved by rotating the focus lever 362 to thereby perform the focus adjustment.

The lens shift mechanism 7 supports the projection lens 36 so as to allow the projection lens 36 to move in predetermined directions, and is attached to the optical component housing 37. Specifically, the lens shift mechanism 7 is configured so as to be able to move the projection lens in two directions (±X direction and ±Z direction) perpendicular to each other in a plane perpendicular to the optical axis 36C taking the state in which the light axis 35C and the optical axis 36C roughly coincide with each other as a reference state. The lens shift mechanism 7 will be explained later in detail.

Although not explained in detail, the power supply device 4 is provided with a power supply block and a light source drive block (both not shown) for driving the light source device 31, and supplies the electronic components such as the control section and the light source 311 with electric power.

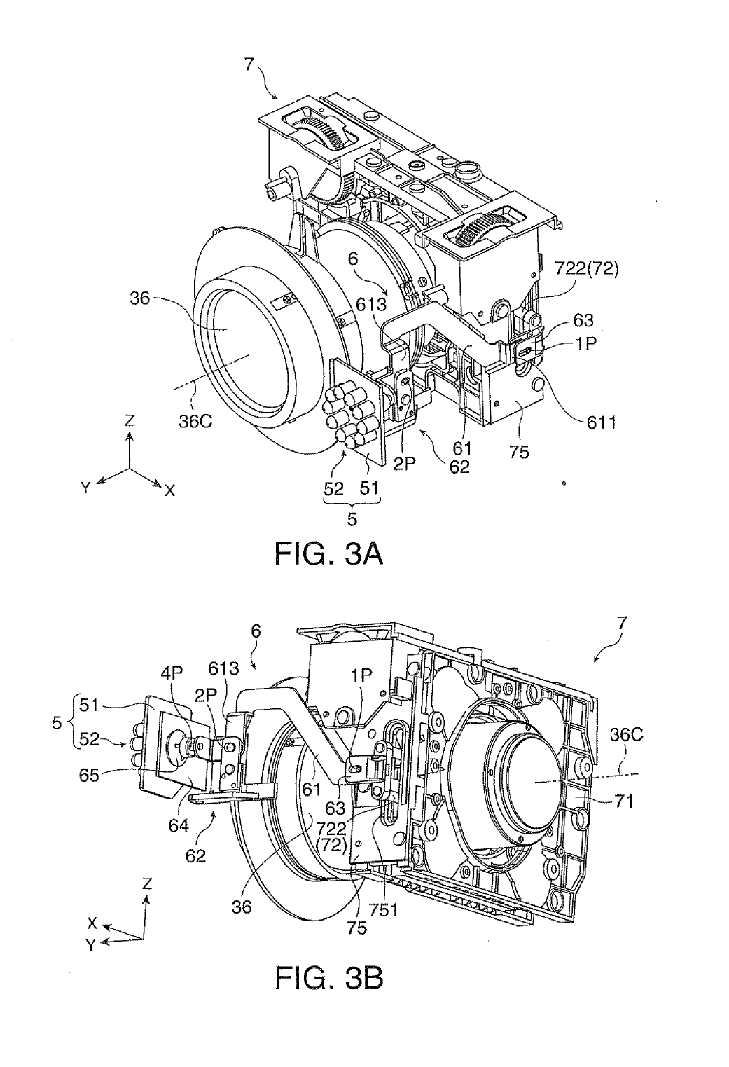

The transmitting device 5 is disposed inside the front case 23, and as described above, the optical filter 24 (see FIG. 1) is disposed in front thereof. The transmitting device 5 has a plurality of light emitting sections 52 (see FIGS. 3A and 3B) and outputs the optical signal synchronous with the switching between the right-eye image and the left-eye image toward the screen based on an instruction of the control section.

As shown in FIG. 2, the interlocking mechanism 6 is configured so as to couple the lens shift mechanism 7 and the transmitting device 5 with each other to thereby move the transmitting device 5 in conjunction with the lens shift mechanism 7. In other words, when the lens shift mechanism 7 is driven, the image projected on the screen moves, and at the same time, the optical signal output from the transmitting device 5 also moves. It should be noted that the transmitting device 5 and the interlocking mechanism 6 will be explained later in detail.

### Configuration of Lens Shift Mechanism

Here, the lens shift mechanism 7 will be explained.

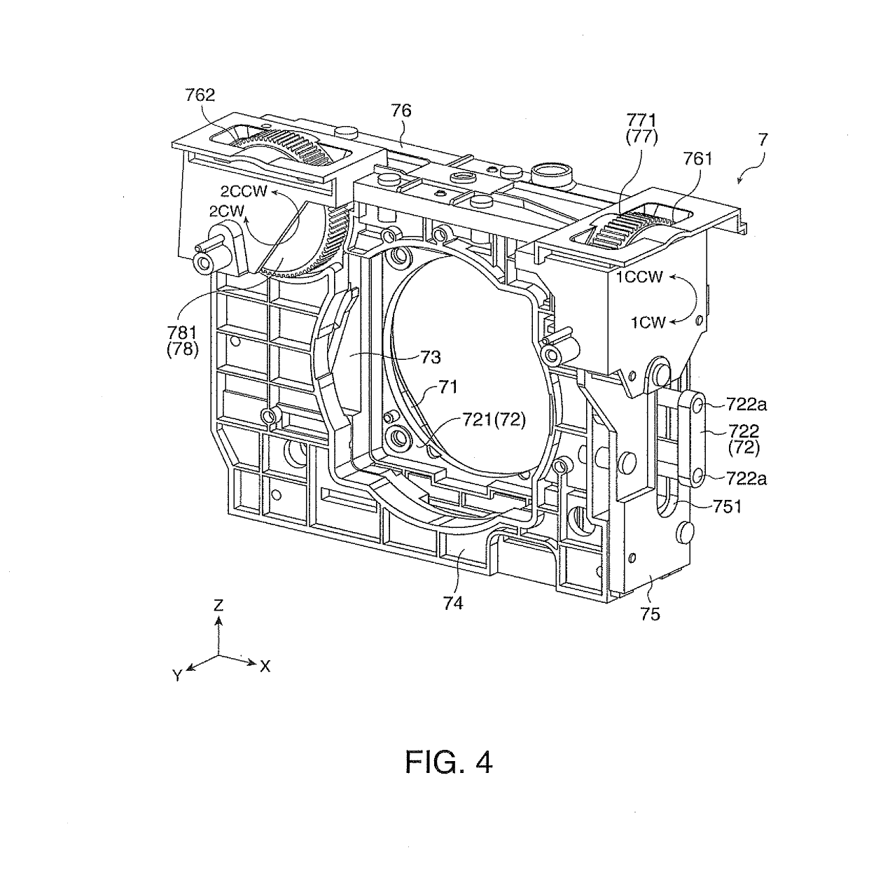

FIGS. 3A and 3B are perspective views of the projection lens 36, the lens shift mechanism 7, the transmitting device 5, and the interlocking mechanism 6, wherein FIG. 3A is a diagram thereof viewed obliquely from front, and FIG. 3B is a diagram thereof viewed obliquely from behind. FIG. 4 is a perspective view of the lens shift mechanism 7.

As shown in FIG. 4, the lens shift mechanism 7 is provided with a fixation plate 71, a first moving section 72, a second moving section 73, an auxiliary plate 74, a support plate 75, an upper cover 76, a first drive section 77, and a second drive section 78.

As shown in FIG. 4, the fixation plate 71, the first moving section 72, the second moving section 73, and the auxiliary plate 74 are sequentially disposed from rear to front, and are each provided with an opening section through which the projection lens 36 is inserted.

The fixation plate 71 is a member which is fixed to the optical component housing 37, and supports the whole of the lens shift mechanism 7.

The first moving section 72 is a member to which the projection lens 36 is attached, and is configured so as to be able to move in the X direction and the vertical direction (the Z direction) together with the projection lens 36 with respect to the fixation plate 71.

As shown in FIG. 4, the first moving section 72 has a lens holding section 721 to which the projection lens 36 is attached, and a protruding section 722 protruding from the +X side of the lens holding section 721 in the +X direction.

The lens holding section 721 is provided with a plurality of screw holes, and the projection lens 36 is attached to the first moving section 72 by fixing the flange section to the +Y side of the lens holding section 721 with screws.

The protruding section 722 extends in the +X direction, and has two cylindrical sections disposed side by side along the Z direction, and a connection section having a track shape in a plan view, and formed so as to bridge the tip portions of the two cylindrical sections. The connection section of the protruding section 722 is a region attached with a shift-side support section 63 (see FIGS. 3A and 3B), described later, of the interlocking mechanism 6, and a plurality of screw holes 722a is disposed on the surface thereof on the +X side.

The second moving section 73 is formed having an engaging section not shown, and is configured so as to be able to move in the X direction together with the first moving section 72 while guiding the vertical (Z-direction) movement of the first moving section 72.

The auxiliary plate 74 mounts the first moving section 72 and the second moving section 73 by sandwiching them together with the fixation plate 71. The auxiliary plate 74 is formed having an engaging section not shown, and guides the second moving section 73 to move in the X direction.

As shown in FIG. 4, the support plate 75 is disposed on the +Y side of the fixation plate 71 and the auxiliary plate 74. The support plate 75 is provided with an opening section 751, and the protruding section 722 of the first moving section 72 is projected from the opening section 751.

As shown in FIG. 4, the upper cover 76 is disposed above the fixation plate 71 and the auxiliary plate 74, and supports the first moving section 77 and the second moving section 78. The upper cover 76 is provided with opening sections 761, 762 from which the first and second dials 771, 781 are partially exposed, respectively.

The first drive section 77 is provided with the first dial 771, and a gear train section composed of a plurality of gear wheels not shown. The first dial 771 is formed having a roughly columnar shape, and is disposed so as to have the upper side thereof exposed from the upper cover 76, and to be rotatable around the central axis along the X direction as shown in FIG. 4.

Then, when the first dial 771 is rotated, the first moving section 72 is moved due to the rotation of the first dial 771 transmitted thereto via the gear train section of the first drive section 77. Specifically, when the first dial 771 is rotated clockwise (in “1CW” direction in FIG. 4) viewed from the +X direction, the first moving section 72 moves upward (in the +Z direction), and when the first dial 771 is rotated counterclockwise (in “1CCW” direction in FIG. 4), the first moving section 72 moves downward (in the −Z direction). Further, it results that the protruding section 722 of the first moving section 72 moves up and down inside the opening section 751. Then, the projection lens 36 fixed to the first moving section 72 moves together with the first moving section 72.

The second drive section 78 is provided with the second dial 781, and a gear train section composed of a plurality of gear wheels not shown. Similarly to the first dial 771, the second dial 781 is formed having a roughly columnar shape, and is disposed so as to have the upper side thereof exposed from the upper cover 76, and to be rotatable around the central axis along the Y direction as shown in FIG. 4.

Then, when the second dial 781 is rotated, the second moving section 73 is moved due to the rotation of the second dial 781 transmitted thereto via the gear train section of the second drive section 78. Specifically, when the second dial 781 is rotated clockwise (in “2CW” direction in FIG. 4) viewed from the +Y direction, the second moving section 73 moves in the +X direction, and when the second dial 781 is rotated counterclockwise (in “2CCW” direction in FIG. 4), the second moving section 73 moves in the −X direction. Further, it results that the protruding section 722 of the first moving section 72 moves so as to vary the protruding length thereof from the opening section 751. Then, the first moving section 72 engaging with the second moving section 73 moves together with the second moving section 73. Therefore, the projection lens 36 fixed to the first moving section 72 also moves together with the second moving section 73.

### Configuration of Transmitting Device

Hereinafter, the transmitting device 5 will be explained in detail.

As shown in FIGS. 3A and 3B, the transmitting device 5 is supported by the interlocking mechanism 6, and is disposed on the +X side of the projection lens 36. The transmitting device 5 is provided with a circuit board 51 and a plurality of light emitting sections 52.

As shown in FIGS. 3A and 3B, the circuit board 51 is formed to have a rectangular planar shape.

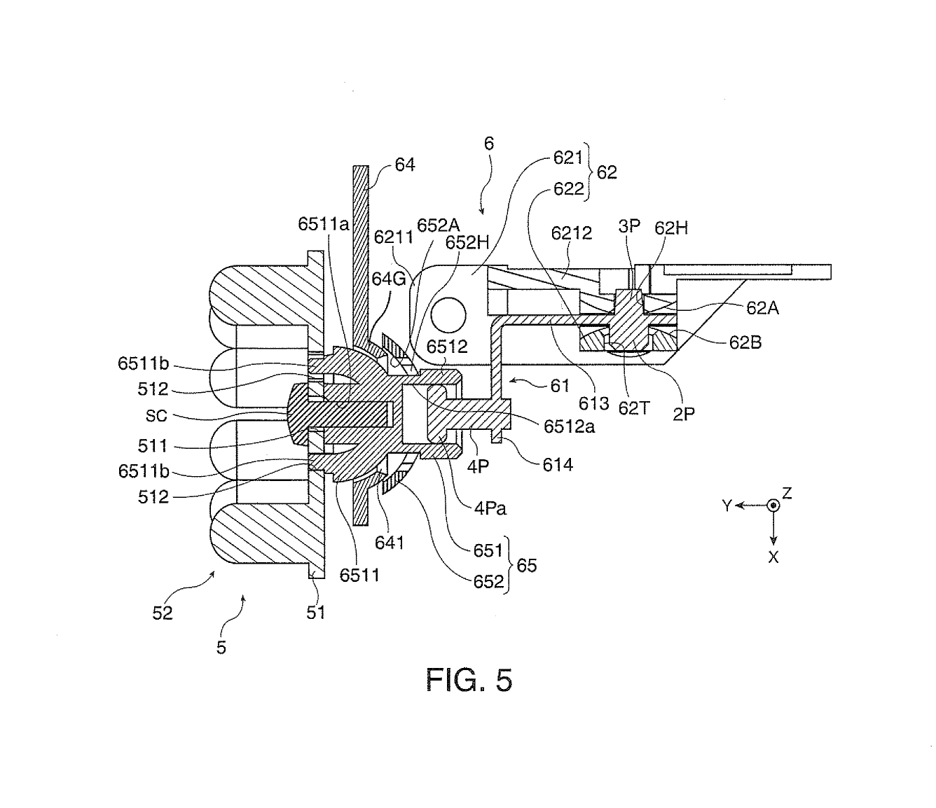

FIG. 5 is a cross-sectional view partially showing the transmitting device 5 and the interlocking mechanism 6. As shown in FIG. 5, the circuit board 51 is provided with a circular hole 511 through which a screw is inserted formed in the center portion, and a plurality of positioning holes 512 is disposed in the vicinity of the circular hole 511.

The plurality of light emitting sections 52 is mounted on the front (+Y side) surface (a mounting surface) of the circuit board 51 so as to output the optical signal frontward (in the +Y direction). Further, the plurality of light emitting sections 52 is disposed in a circular pattern on the periphery of the circular hole 511. In the light emitting sections 52 of the present embodiment, there are adopted light emitting diodes (LED) for outputting an infrared light. It should be noted that the light emitting sections 52 are not limited to the LED for outputting the infrared light, but can also be optical elements for outputting optical signal in other wavelength ranges.

In the transmitting device 5, the circuit board 51 is connected to the control section via a cable not shown, and the plurality of light emitting sections 52 outputs the optical signal based on the instruction of the control section.

The transmitting device 5 is held by a transmitting device holding section 65 (see FIG. 5), described later, of the interlocking mechanism 6, and is disposed so that the mounting surface is roughly perpendicular to the optical axis 36C in the reference state. Further, the transmitting device 5 moves together with the transmitting device holding section 65 moving in conjunction with the lens shift mechanism 7.

### Configuration of Interlocking Mechanism

The interlocking mechanism 6 couples the first moving section 72 of the lens shift mechanism 7 and the transmitting device 5 with each other. Further, the interlocking mechanism 6 is configured so as to move the transmitting device 5, specifically vary the tilt angle with respect to the optical axis 36C, in conjunction with the movement of the first moving section 72.

As shown in FIGS. 3A and 3B, the interlocking mechanism 6 is disposed on the +X side of the projection lens 36 and the lens shift mechanism 7, and behind the transmitting device 5.

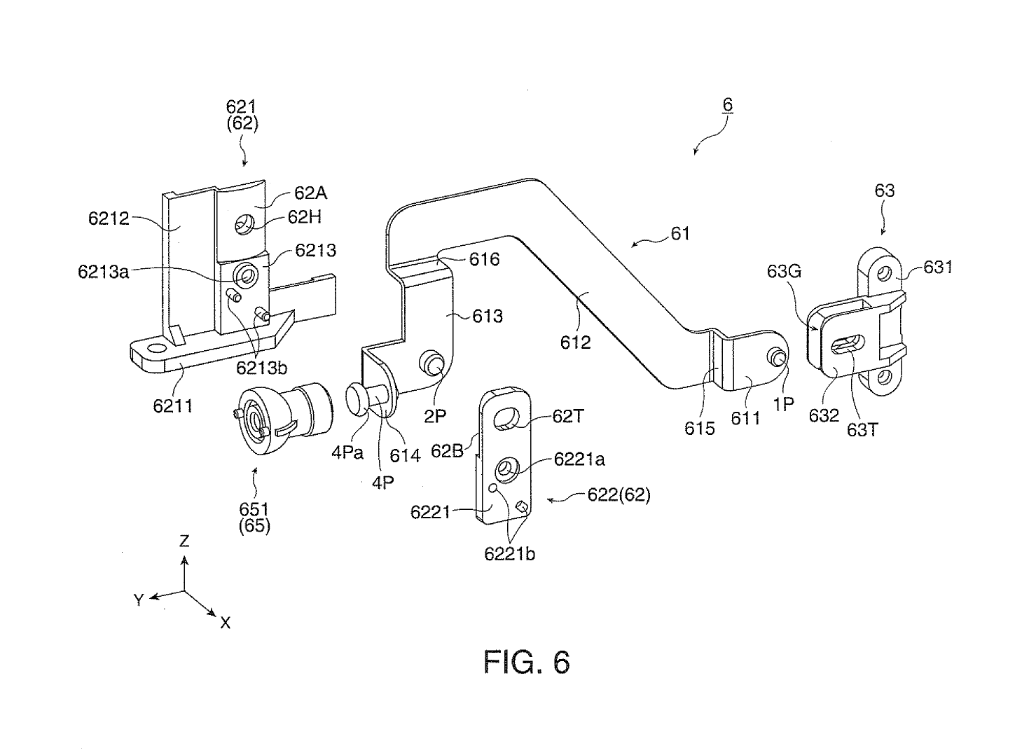

FIG. 6 is an exploded perspective view of the interlocking mechanism 6, and a diagram omitting some of the members. As shown in FIG. 6, the interlocking mechanism 6 is provided with a connecting lever 61, a lever support section 62, the shift-side support section 63, a transmitting device guide section 64 (see FIG. 5), and the transmitting device holding section 65.

The connecting lever 61 is formed by processing a metal plate member, and extends from the side of the lens shift mechanism 7 to the back of the transmitting device 5 as shown in FIGS. 3A and 3B.

Specifically, as shown in FIG. 6, the connecting lever 61 has a shift-side connecting section 611 having a rectangular planar shape disposed on the side of the lens shift mechanism 7 (see FIGS. 3A and 3B). The connecting lever 61 further includes an arm section 612, a base section 613, and a transmitting-side connection section 614 formed in sequence from the end portion of the shift-side connecting section 611. It should be noted that the material of the connecting lever 61 is not limited to metal, but can also be synthetic resin.

As shown in FIG. 6, a connecting pin 1P having a columnar shape and protruding in the +X direction is provided to the shift-side connecting section 611 by swaging or the like.

The arm section 612 is connected to the shift-side connecting section 611 via a bend section 615 bent to the −X side with respect to the shift-side connecting section 611. The arm section 612 is formed so as to extend from the end portion of the bent section 615 obliquely toward upper front, and then extend frontward.

The base section 613 is connected to the arm section 612 via a bend section 616 bent to the +X side with respect to the arm section 612. The base section 613 is formed to have an L planar shape so as to extend downward from the end portion of the bend section 616, and then extend frontward. It should be noted that in the space located below the arm section 612 and on the +X side of the arm section 612, there are disposed the members such as a duct not shown.

Further, as shown in FIGS. 5 and 6, a guide pin 2P having a columnar shape and protruding in the +X direction, and a pivot pin 3P protruding in the −X direction are provided to the base section 613 by swaging or the like. The guide pin 2P and the pivot pin 3P are formed to have the respective central axes coaxial with each other, and as shown in FIG. 5, the pivot pin 3P is formed having a taper portion with a diameter of the tip side smaller than a diameter of the base end side.

As shown in FIG. 6, the transmitting-side connecting section 614 is formed so as to be bent at the end portion of the base section 613 in the +X direction, and an action pin 4P protruding frontward is disposed by swaging or the like.

As shown in FIGS. 5 and 6, the action pin 4P has a shape with which two columnar regions with respective diameters different from each other are connected to each other, and is attached to the transmitting-side connecting section 614 so that an action section 4Pa with a larger diameter is located in front. Further, round chamfering process is performed on the peripheral section of the action pin 4P so as to have a curved surface.

The lever support section 62 is configured so as to support the base section 613 of the connecting lever 61. As shown in FIGS. 5 and 6, the lever support section 62 is provided with a base section 621 and a base aiding section 622.

The base section 621 has a seating section 6211 formed along the X-Y plane, and an extending section 6212 extending upward from the seating section 6211.

The seating section 6211 is provided with a circular hole, and the base section 621 is attached to a member (not shown) to be fixed to the lower case 22 by a screw inserted into the circular hole.

As shown in FIG. 6, the extending section 6212 has a guide surface 62A for guiding the −X-side surface of the base section 613, and a holding section 6213 located below the guide surface 62A.

As shown in FIG. 5, the guide surface 62A is formed to have a roughly spherical shape convex toward the +X side. Further, the center portion of the guide surface 62A is provided with a support hole 62H penetrating in the X direction, and for supporting the pivot pin 3P.

The holding section 6213 is provided with a screw hole 6213a, and columnar protrusions 6213b protruding in the +X direction.

As shown in FIG. 6, the base aiding section 622 is formed to have a shape opposed to the guide surface 62A of the extending section 6212 and the holding section 6213. Specifically, the base aiding section 622 has a guide surface 62B (see FIG. 5) for guiding the +X-side surface of the base section 613, and an attachment section 6221 located below the guide surface 62B, and opposed to the holding section 6213.

As shown in FIG. 5, the guide surface 628 is formed to have a roughly spherical shape convex toward the −X side. Further, the center portion of the guide surface 62B is provided with a track hole 62T penetrating in the X direction, and for supporting the guide pin 2P. The track hole 62T is formed so as to have the inner diameter in the Y direction larger than the inner diameter in the Z direction. In other wards, it results that the guide pin 2P is slidably supported by the track hole 62T in the Y direction.

The attachment section 6221 is provided with circular holes 6221a formed at positions opposed to the respective screw holes 6213a of the holding section 6213, and holes 6221b formed at positions opposed to the respective protrusions 6213b.

The base aiding section 622 is screwed to the base section 621 to thereby support the base section 613 together with the base section 621. Specifically, the layer support section 62 supports the pivot pin 3P and the guide pin 2P respectively with the support hole 6211 and the track hole 62T, and further supports the both surfaces of the base section 613 with the guide surfaces 62A, 628. Further, it results that the connecting lever 61 is supported by the lever support section 62 so as to be rotatable around the central axis of the pivot pin 3P in the Y-Z plane, and so that the tilt angle with respect to the Y-Z plane can be varied taking the region at which the pivot pin 3P and the support hole 62H have contact with each other as a pivot point.

As shown in FIGS. 3A and 3B, the shift-side support section 63 is fixed to the protruding section 722 of the lens shift mechanism 7 to thereby support the shift-side connecting section 611 of the connecting lever 61.

As shown in FIG. 6, the shift-side support section 63 has an attachment section 631 extending in a vertical direction, and a protruding section 632 protruding from the +X-side surface of the attachment section 631 in the +X direction and the +Y direction. In the vicinity of the upper and lower end portions of the attachment section 631, there are disposed circular holes, and the shift-side support section 63 is fixed to the protruding section 722 by screws inserted into the circular holes.

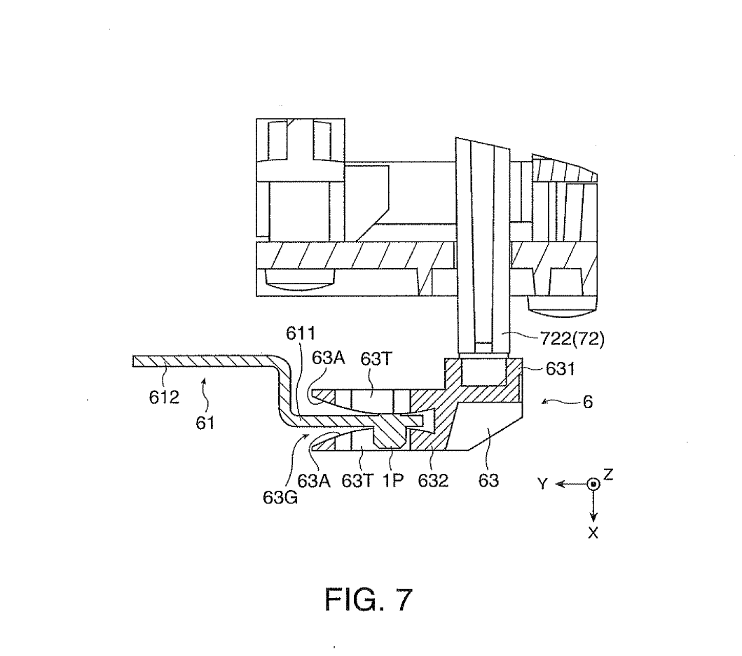

FIG. 7 is a cross-sectional view showing the interlocking mechanism 6 in the vicinity of the shift-side support section 63.

As shown in FIG. 7, a region of the protruding section 632 protruding toward the +Y direction is provided with a guide groove 63G penetrating in a vertical direction. The inner surfaces (the guide surfaces 63A) of the guide groove 63G are formed to have each a roughly spherical convex surface.

Further, the center portion of each of the guide surfaces 63A is provided with a track hole 63T penetrating in the X direction, and for supporting the connecting pin 1P. The track hole 63T is formed so as to have the inner diameter in the Y direction larger than the inner diameter in the Z direction. In other wards, it results that the connecting pin 1P is slidably supported by the track hole 63T in the Y direction.

As shown in FIG. 7, the shift-side support section 63 has the shift-side connecting section 611 inserted in the guide groove 63G and the connecting pin 1P inserted in the track hole 63T to thereby support the shift-side connecting section 611. Specifically, the shift-side support section 63 supports the connecting pin 1P with the track hole 63T, and supports the both surfaces of the shift-side connecting section 611 with the two guide surfaces 63A opposed to each other.

Further, the shift-side support section 63 rotates the connecting lever 61 in the Y-Z plane when the first moving section 72 is moved in a vertical direction, and varies the tilt angle of the connecting lever 61 with respect to the Y-Z plane when the first moving section 72 is moved in the X direction.

As shown in FIGS. 3A, 3B, and 5, the transmitting device guide section 64 is disposed between the transmitting device 5 and the connecting lever 61, and rotatably supports the transmitting device holding section 65.

The transmitting device guide section 64 is formed of a plate, and as shown in FIG. 5, disposed along the X-Z plane. The transmitting device guide section 64 has a guide section 64G having a front surface shaped like a roughly spherical concave surface and a rear surface shaped like a roughly spherical convex surface, and the center portion of the guide section 64G is provided with a hole 641 penetrating in a front-back direction. The transmitting device guide section 64 is fixed to the lower case 22 via a member not shown.

The transmitting device holding section 65 holds the transmitting device 5, and is rotatably supported by the transmitting device guide section 64. As shown in FIG. 5, the transmitting device holding section 65 is provided with a board holding section 651 and a rotation guide section 652.

The board holding section 651 has a semispherical section 6511 having a outer shape of cutting a sphere in half, and a cylindrical section 6512 protruding from a center portion of the spherical side of the semispherical section 6511 and formed to have a cylindrical shape.

The semispherical section 6511 has the spherical side formed to have a shape smoothly rotatable on the concave surface of the guide section 64G, and is provided with a screw hole 6511a and a plurality of protruding sections 6511b disposed on the opposite side to the spherical side. The screw hole 6511a is formed at the position corresponding to the circular hole 511 of the circuit board 51 of the transmitting device 5, and the plurality of protruding sections 6511b is formed so as to be inserted into the plurality of positioning holes 512 of the circuit board 51.

As shown in FIG. 5, the cylindrical section 6512 is provided with a cylindrical recessed section 6512a opening backward, and the action section 4Pa of the action pin 4P is inserted into the recessed section 6512a. Further, the cylindrical section 6512 is formed having a step where the diameter on the semispherical section 6511 side is smaller than the diameter on the tip side.

The circuit board 51 is positioned by inserting the protruding section 6511b into the positioning holes 512, and is fixed to the semispherical section 6511 by the screw SC inserted into the circular hole 511. Further, as shown in FIG. 5, the board holding section 651 attached with the circuit board 51 is disposed while the spherical side of the semispherical section 6511 is opposed to the concave surface of the guide section 64G, and the cylindrical section 6512 is inserted in the hole 641.

The rotation guide section 652 holds the guide section 64G together with the semispherical section 6511 so that the transmitting device holding section 65 becomes rotatable with respect to the guide section 64G.

As shown in FIG. 5, the rotation guide section 652 has a roughly spherical concave surface (a concave section 652A) opposed to the convex surface of the guide section 64G, and the center portion of the concave section 652A is provided with a through hole 652H.

The rotation guide section 652 is locked by the step section of the cylindrical section 6512 inserted in the through hole 652H to thereby be fixed, and the transmitting device holding section 65 is rotatably supported by the guide section 64G.

### Operation of Interlocking Mechanism

Here, an operation of the interlocking mechanism 6 will be explained.

As described above, the interlocking mechanism 6 varies the tilt angle of the transmitting device 5 in conjunction with the first moving section 72 of the lens shift mechanism 7.

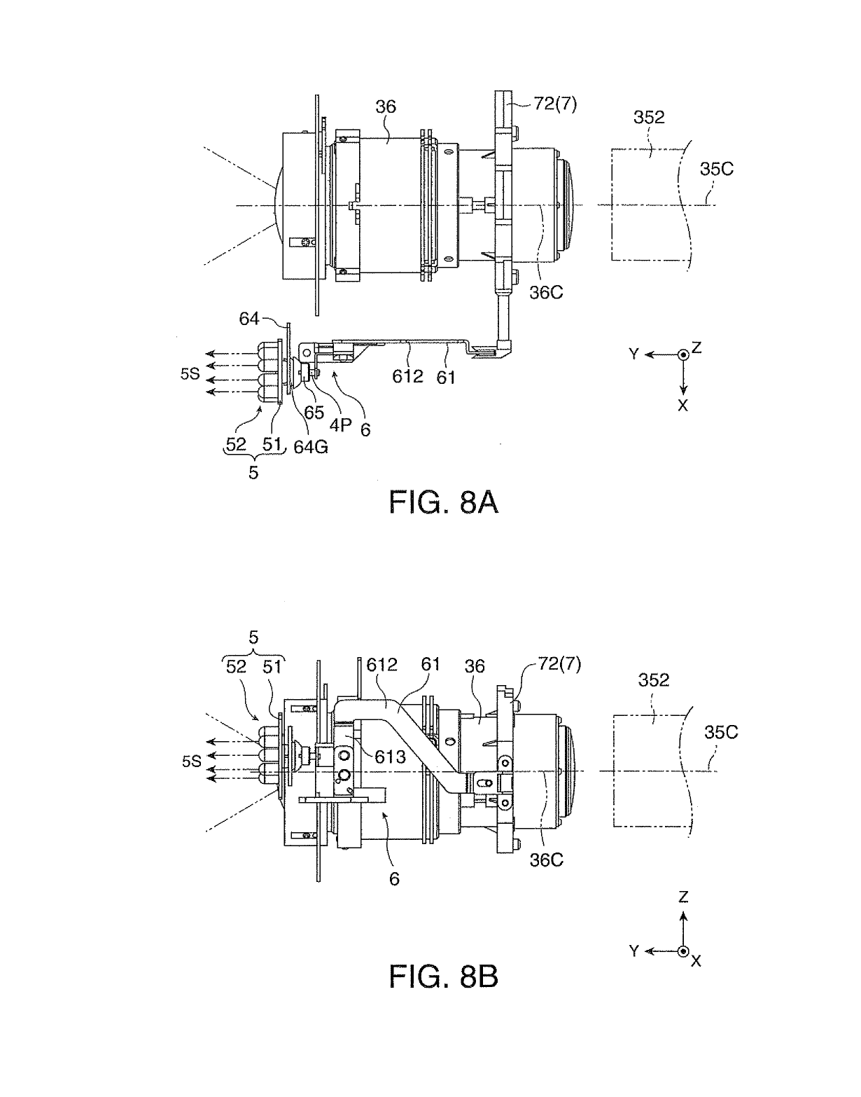

FIGS. 8A and 8B are diagrams showing the projection lens 36, the first moving section 72, the interlocking mechanism 6, and the transmitting device 5 in a reference state, wherein FIG. 8A is a diagram thereof viewed from above, and FIG. 8B is a diagram thereof viewed from the +X direction.

As shown in FIGS. 8A and 8B, in the reference state, the connecting lever 61 becomes in the state in which the arm section 612 is disposed along the Y-Z plane, and the base section 613 having the L shape is disposed along the vertical direction (the Z direction) and the front-back direction (the Y direction). In the reference state, the light projected from the projection lens 36 is emitted cantered on the optical axis 36C. Further, the transmitting device 5 is disposed so that the mounting surface of the circuit board 51 is roughly perpendicular to the optical axis 36C of the projection lens 36, and the optical signal 55 output from the light emitting sections 52 is emitted in the direction along the optical axis 36C.

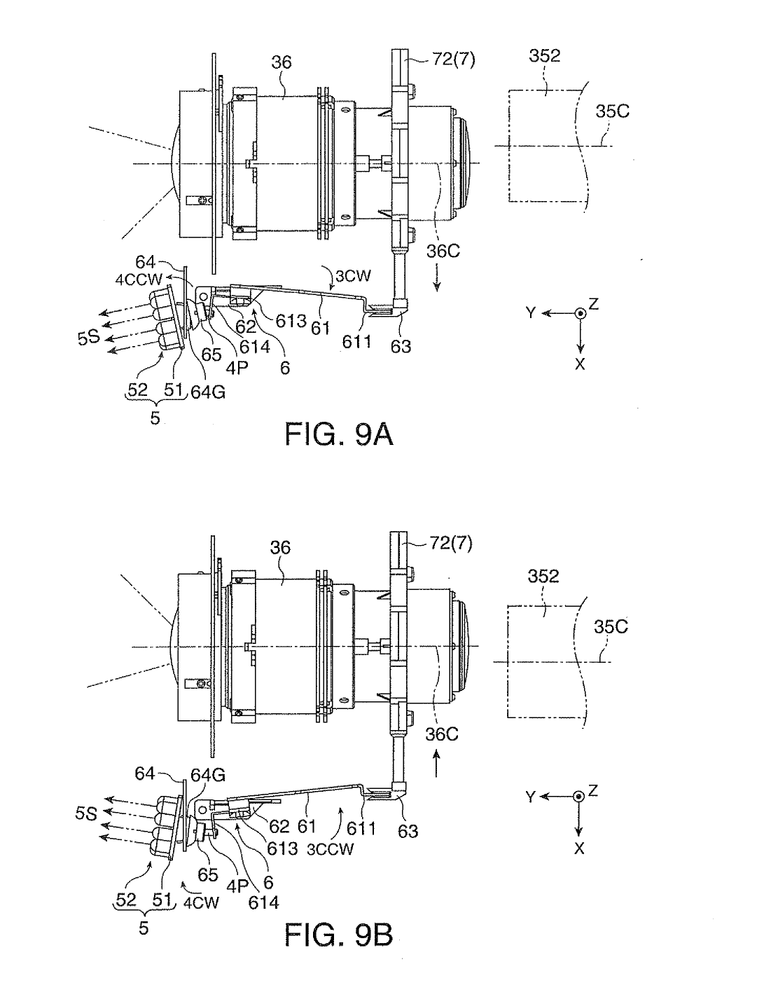

Firstly, an operation of the interlocking mechanism 6 in the case in which the projection lens 36 is moved in the X direction from the reference state will be explained. FIGS. 9A and 9B are diagrams of the projection lens 36, the first moving section 72, the interlocking mechanism 6, and the transmitting device 5 viewed from above, wherein FIG. 9A is a diagram corresponding to the state in which the projection lens 36 is moved in the +X direction from the reference state, and FIG. 9B is a diagram corresponding to the state in which the projection lens 36 is moved in the −X direction from the reference state.

As described above, the projection lens 36 moves in the +X direction when the second dial 781 of the lens shift mechanism 7 is rotated clockwise (in the 2CW direction in FIG. 4). Then, as shown in FIG. 9A, when the projection lens 36 is moved in the +X direction, namely the direction of coming closer to the transmitting device 5, from the reference state, the light projected from the projection lens 36 is emitted while tiled toward the +X side with respect to the optical axis 36C.

As shown in FIG. 9A, when the projection lens 36 is moved in the +X direction from the reference state, the shift-side support section 63 fixed to the first moving section 72 also moves in the +X direction. When the shift-side support section 63 moves in the +X direction, the shift-side connecting section 611 supported by the shift-side support section 63 moves in the +X direction to thereby rotate the connecting lever 61 clockwise (in the 3CW direction in FIG. 9A) viewed from above taking the base section 613 supported by the lever support section 62 as a pivot point.

As shown in FIG. 9A, when the connecting lever 61 rotates in the 3CW direction, it results that the action pin 4P moves in the −X direction with respect to the reference state. Further, since the connecting lever 61 has the base section 613 which is formed at a position closer to the transmitting-side connecting section 614 than to the shift-side connecting section 611, the displacement of the action pin 4P due to the rotation of the connecting lever 61 becomes smaller than the displacement of the shift-side connecting section 611.

Further, when the action pin 4P moves in the −X direction, the transmitting device holding section 65 having the action section 4Pa inserted in the recessed section 6512a (see FIG. 5) is guided by the guide section 64G of the transmitting device guide section 64, and rotates counterclockwise (in the 4CCW direction in FIG. 9A) viewed from above, namely in the opposite direction to the rotational direction of the connecting lever 61. Then, the transmitting device 5 held by the transmitting device holding section 65 rotates in the 4CCW direction together with the transmitting device holding section 65. Therefore, the transmitting device 5 rotates so that the −X side is located in front of the +X side, and the tilt angle with respect to the optical axis 36C is varied.

Further, the optical signal 5S output from the light emitting sections 52 is output while tilted toward the +X side with respect to the optical axis 36C, namely while tilted in the same direction as the tilt direction of the light emitted from the projection lens 36. In other words, the transmitting device 5 is varied in the tilt angle so that the optical signal 5S moves in the same direction as the moving direction of the projection lens 36. Further, the larger the displacement of the projection lens 36 is, the larger the tilt angle of the transmitting device 5 with respect to the optical axis 36C becomes, and the optical signal 5S moves so as to follow the image to be moved.

In contrast, as described above, the projection lens 36 moves in the −X direction when the second dial 781 of the lens shift mechanism 7 is rotated counterclockwise (the 2CCW direction in FIG. 4). Then, as shown in FIG. 9B, when the projection lens 36 is moved in the −X direction, namely the direction of getting away from the transmitting device 5, from the reference state, the light projected from the projection lens 36 is emitted while tiled toward the −X side with respect to the optical axis 36C.

When the projection lens 36 is moved in the −X direction from the reference state, the interlocking mechanism 6 operates in the opposite direction to the case in which the projection lens 36 is moved in the +X direction.

Specifically, as shown in FIG. 9B, when the projection lens 36 is moved in the −X direction from the reference state, the connecting lever 61 rotates counterclockwise (in the 3CCW direction) viewed from above taking the base section 613 as the pivot point. Then, the transmitting device 5 held by the transmitting device holding section 65 is guided by the guide section 64G, and rotates clockwise (in the 4CW direction in FIG. 9B) viewed from above. Therefore, the transmitting device 5 rotates so that the +X side is located in front of the −X side, and the tilt angle with respect to the optical axis 36C is varied.

Further, the optical signal 5S output from the light emitting sections 52 is output while tilted toward the −X side with respect to the optical axis 36C, namely while tilted in the same direction as the tilt direction of the light emitted from the projection lens 36. Therefore, also in the case in which the projection lens 36 is moved in the −X direction from the reference state, the optical signal 5S moves so as to follow the image to be moved similarly to the case in which the projection lens 36 is moved in the +X direction.

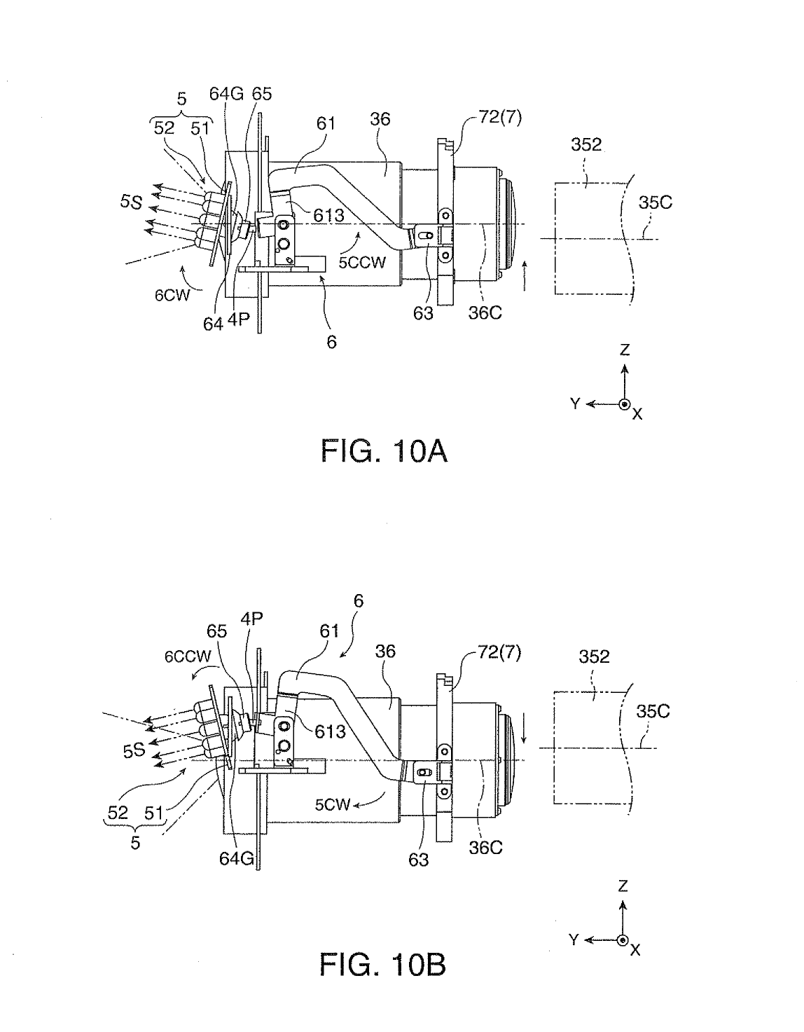

Then, an operation of the interlocking mechanism 6 in the case in which the projection lens 36 is moved in the vertical direction (the Z direction) from the reference state will be explained. FIGS. 10A and 10B are diagrams of the projection lens 36, the first moving section 72, the interlocking mechanism 6, and the transmitting device 5 viewed from the +X direction, wherein FIG. 10A is a diagram corresponding to the state in which the projection lens 36 is moved upward (in the +Z direction) from the reference state, and FIG. 10B is a diagram corresponding to the state in which the projection lens 36 is moved downward (in the direction) from the reference state.

As described above, the projection lens 36 moves upward when the first dial 771 is rotated clockwise (the 1CW direction in FIG. 4). Then, as shown in FIG. 10A, when the projection lens 36 is moved upward from the reference state, the light projected from the projection lens 36 is emitted while tiled upward with respect to the optical axis 36C.

As shown in FIG. 10A, when the projection lens 36 is moved upward from the reference state, the shift-side support section 63 fixed to the first moving section 72 also moves upward. When the shift-side support section 63 moves upward, the shift-side connecting section 611 supported by the shift-side support section 63 moves upward to thereby rotate the connecting lever 61 counterclockwise (the 5CCW direction in FIG. 10A) viewed from the +X direction taking the base section 613 as a pivot point.

As shown in FIG. 10A, when the connecting lever 61 rotates in the 5CCW direction, it results that the action pin 4P moves downward with respect to the reference state. When the action pin 4P moves downward, the transmitting device holding section 65 having the action section 4Pa inserted in the recessed section 6512a (see FIG. 5) is guided by the guide section 64G, and rotates clockwise (in the 6CW direction in FIG. 10A) viewed from the +X direction, namely in the opposite direction to the rotational direction of the connecting lever 61.

Then, the transmitting device 5 held by the transmitting device holding section 65 rotates in the 6CW direction together with the transmitting device holding section 65. Therefore, the transmitting device 5 rotates so that the lower side is located in front of the upper side, and the tilt angle with respect to the optical axis 36C is varied. Further, the optical signal 5S output from the light emitting sections 52 is output while tilted upward with respect to the optical axis 36C, namely while tilted in the same direction as the tilt direction of the light emitted from the projection lens 36.

In contrast, as described above, the projection lens moves downward when the first dial 771 is rotated counterclockwise (the 1CCW direction in FIG. 4). Then, as shown in FIG. 10B, when the projection lens 36 is moved downward from the reference state, the light projected from the projection lens 36 is emitted while tiled downward with respect to the optical axis 36C.

When the projection lens 36 is moved downward from the reference state, the interlocking mechanism 6 operates in the opposite direction to the case in which the projection lens 36 is moved upward.

Specifically, as shown in FIG. 10B, when the projection lens 36 is moved downward from the reference state, the connecting lever 61 rotates clockwise (in the 5CW direction) viewed from the +X direction taking the base section 613 as the pivot point. Then, the transmitting device 5 held by the transmitting device holding section 65 is guided by the guide section 64G, and rotates counterclockwise (in the 6CCW direction in FIG. 10B) viewed from the +X direction. Therefore, the transmitting device 5 rotates so that the upper side is located in front of the lower side, and the tilt angle with respect to the optical axis 36C is varied.

Further, the optical signal 5S output from the light emitting sections 52 is output while tilted downward with respect to the optical axis 36C, namely while tilted in the same direction as the tilt direction of the light emitted from the projection lens 36. Therefore, also in the case in which the projection lens 36 is moved in the vertical direction from the reference state, the optical signal 5S moves so as to follow the image to be moved similarly to the case in which the projection lens 36 is moved in the X direction.

As described above, in conjunction with the lens shift mechanism 7, the interlocking mechanism 6 varies the tilt angle of the transmitting device 5 with respect to the optical axis 36C so that the optical signal 5S output from the transmitting device 5 moves in the same direction as the moving direction of the projection lens 36. Specifically, in conjunction with the movement of the projection lens 36 in a predetermined direction, the interlocking mechanism 6 moves the transmitting device 5 so that the direction of the output of the optical signal 5S changes to the predetermined direction.

### Principal Configuration of Image Display System

As described above, the image display system is configured including the projector 1 and the image-observing spectacles.

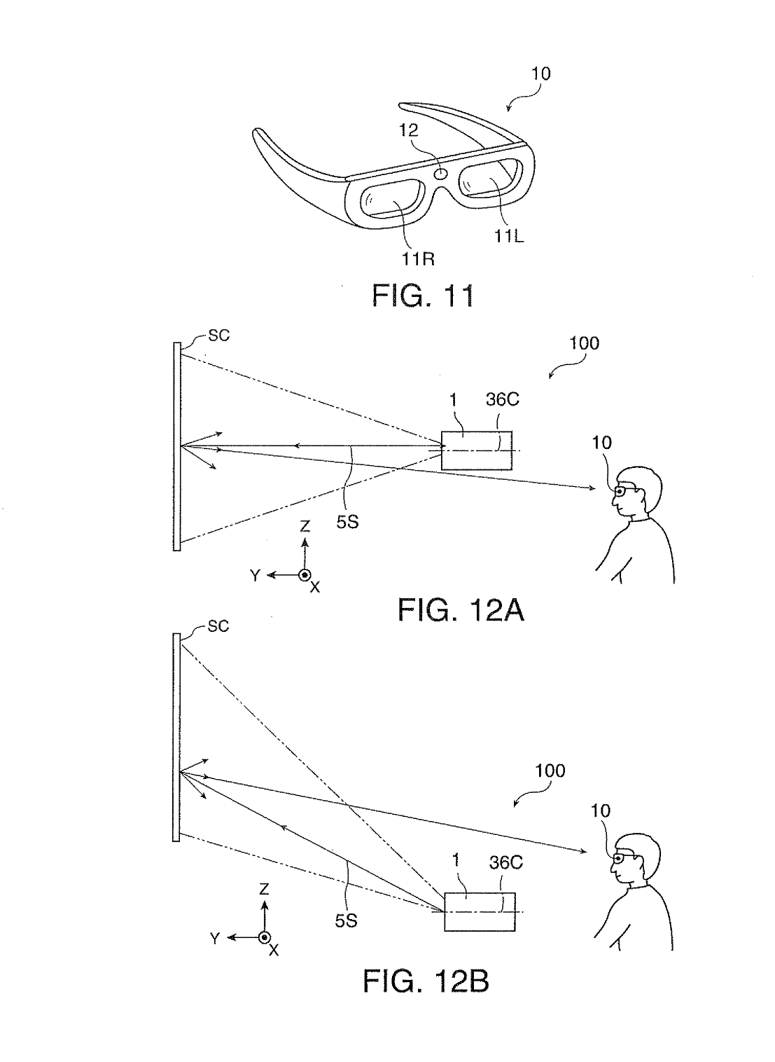

FIG. 11 is a perspective view schematically showing an external appearance of the image observing spectacles 10 according to the present embodiment.

As shown in FIG. 11, the image observing spectacles 10 are provided with a right-eye shutter (a liquid crystal shutter 11R) located in front of the right eye of the observer wearing the image observing spectacles 10, a left-eye shutter (a liquid crystal shutter 11L) located in front of the left eye, a receiving section 12 for receiving the optical signal 5S, and a drive section (not shown) for driving the liquid crystal shutters 11R, 11L.

The liquid crystal shutters 11R, 11L each have a configuration of bonding polarization plates to both of obverse and reverse surfaces of the liquid crystal panel. The liquid crystal shutter 11R is switched between an open state for transmitting (passing) the light entering the right eye and a light blocking state for blocking the light due to the drive by the drive section. Similarly, the liquid crystal shutter 11L is switched between an open state for transmitting (passing) the light entering the left eye and a light blocking state for blocking the light due to the drive by the drive section. Further, in the image observing spectacles 10, switching between the open state and the light blocking state is performed alternately on the right and left liquid crystal shutters 11R, 11L by the drive section driving them in accordance with the optical signal 5S.

### Light Path of Optical Signal

Here, the light path of the optical signal 5S output from the transmitting device 5 will be explained.

The optical signal 5S output from the transmitting device 5 is, as described above, transmitted through the optical filter 24 (see FIG. 1) and emitted outside the projector 1, then reflected by the screen, and is then received by the image observing spectacles 10 worn by the observer who observes the image thus projected.

FIGS. 12A and 123 are schematic diagrams of the image display system 100 and the screen SC according to the present embodiment. Specifically, FIG. 12A is a diagram of the case in which the projector 1 and the screen SC are installed so as to be opposed straight to each other, and FIG. 12B is a diagram of the case in which the screen SC is installed in an upper position with respect to the position where the screen SC is opposed straight to the projector 1.

In the case in which the projector 1 and the screen SC are installed so as to be opposed straight to each other, by setting the projection lens 36 to the reference state, the light to be projected is emitted centered on the optical axis 36C, and the image is projected on the screen SC as shown in FIG. 12A.

In the reference state, the optical signal 58 output from the transmitting device 5 is emitted in the direction along the optical axis 36C as described above, and therefore, reaches the inside of the image projected on the screen SC. It should be noted that the optical signal 5S is an infrared light, and therefore does not degrade the quality of the image even if it reaches the inside of the image.

The optical signal 5S having reached the screen. SC is reflected by the screen SC in a diffused manner. Then, a part of the optical signal 5S reflected by the screen SC in a diffused manner proceeds toward the observer who observes the image projected on the screen SC. Therefore, a part of the optical signal 5S reflected by the screen SC in a diffused manner enters the receiving section 12 (see FIG. 11) of the image observing spectacles 10 worn by the observer.

The right and left liquid crystal shutters 11R, 11L are switched between the open state and the light blocking state in accordance with the optical signal 5S received by the receiving section 12. Then, the observer wearing the image observing spectacles 10 observes the left-eye image projected on the screen SC only with the left eye, and observes the right-eye image only with the right eye to thereby recognize the images as a three-dimensional image.

Then, in the case in which the screen SC is installed in an upper position with respect to the position where the screen SC is opposed straight to the projector 1, by moving the projection lens 36 upward from the reference state, the light to be projected is tilted upward with respect to the optical axis 36C, and the image is projected on the screen SC as shown in FIG. 12B.

In the case in which the projection lens 36 is moved upward from the reference state, the transmitting device 5 is tilted upward as described above (see FIG. 9B), and the optical signal 5S output from the transmitting device 5 reaches the inside of the image projected on the screen SC. Then, the optical signal 5S having reached the screen SC is reflected in a diffused manner, and a part thereof enters the receiving section 12 (see FIG. 11) of the image observing spectacles 10 worn by the observer. It should be noted that in the case of the projector not provided with the interlocking mechanism 6, it results that the optical signal 5S output from the transmitting device 5 runs off the screen SC, and fails to reach the receiving section 12 of the image observing spectacles 10.

Although not explained in detail, also in the case in which the projection lens 36 is moved downward or in the ±X directions with respect to the reference state, the optical signal 5S output from the transmitting device 5 reaches the screen SC and is reflected providing the projector 1 is installed so that the image is projected on the screen SC.

Further, although the projection lens 36 is changed in the tilt angle of the light to be projected with respect to the optical axis 36C if the zoom adjustment is performed in the position moved from the reference state, the interlocking mechanism 6 is configured to vary the tilt angle of the transmitting device 5 so that the optical signal 55 reaches the inside of the image to be projected within the zoom adjustment range.

As described above, the projector 1 is capable of reflecting the optical signal 55 with the screen SC to thereby make the optical signal 5S reach the image observing spectacles 10 worn by the observer even in the case in which the relative position to the screen SC is changed providing the position of the projection lens 36 is set so that the image is projected on the screen SC.

As explained hereinabove, according to the projector 1 and the image display system 100 of the present embodiment, the following advantages can be obtained.

1. The projector 1 is provided with the transmitting device 5 for outputting the optical signal 5S synchronous with the switching between the right-eye image and the left-eye image toward the screen SC. Thus, it becomes possible to reflect the optical signal 5S with the screen SC to thereby make the optical signal 5S reach the observer who observes the image projected on the screen SC. Therefore, by setting the projector 1 so that the image is projected on the screen SC, and wearing the image observing spectacles 10, it becomes possible for the observer to easily recognize the image projected on the screen SC as a three-dimensional image.

Further, since the plurality of light emitting sections 52 is provided, it becomes possible to increase the intensity of the optical signal 5S to be reflected by the screen SC to thereby make the optical signal 5S reach the observer located in a wider range. Therefore, it becomes possible for the observer to more surely recognize the image projected on the screen SC as a three-dimensional image.

2. Since the projector 1 is provided with the lens shift mechanism 7 and the interlocking mechanism 6, it becomes possible to project the image, and at the same time, to reliably reflect the optical signal 5S output from the transmitting device 5 using the screen SC even in the case in which the relative position to the screen SC is changed. Therefore, it becomes possible to provide the projector 1 with a lot of flexibility of installation, and capable of projecting the light allowing the observation of a three-dimensional image.

3. The interlocking mechanism 6 is configured to vary the tilt angle of the transmitting device 5 with respect to the optical axis 36C in conjunction with the lens shift mechanism 7. In other words, the interlocking mechanism 6 is configured to vary the direction of the optical signal 5S output from the transmitting device 5 in conjunction with the lens shift mechanism 7. Thus, it becomes possible to largely move the optical signal 59 with a small space compared to the configuration of moving the transmitting device 5 in a sliding manner. Therefore, it becomes possible to prevent the projector 1 from growing in size, and to reliably reflect the optical signal 59 with the screen SC within a range in which the projection lens 36 is moved.

4. The lens shift mechanism 7 is configured to be capable of moving the projection lens 36 in the two directions, namely the vertical direction (the Z direction) and the X direction, and the interlocking mechanism 6 is capable of moving the transmitting device 5 in the two directions in conjunction with the lens shift mechanism 7. Thus, it becomes possible to provide the projector 1 with higher flexibility of installation, and capable of projecting the light allowing the observation of a three-dimensional image.

5. The interlocking mechanism 6 moves the transmitting device 5 in conjunction with the lens shift mechanism 7 so that the optical signal 59 is projected in the inside of the image projected. Thus, it becomes possible for the projector 1 to reflect the optical signal 5S within the image on the screen SC to thereby make the optical signal 59 surely reach the observer observing the image projected even in the case in which the image projected on the screen SC is moved.

6. Since the image display system 100 is provided with the projector 1 and the image observing spectacles 10, it becomes possible for the observer to appreciate high flexibility of installation and to easily observe a three-dimensional image.

### Second Embodiment

Hereinafter, a projector according to a second embodiment will be explained with reference to the accompanying drawings. In the following explanation, similar structures and similar members to those of the projector 1 according to the first embodiment are denoted by the same reference symbols, and the detailed explanation therefor will be omitted or simplified.

The projector according to the present embodiment is provided with a transmitting device 8 and an interlocking mechanism 9 different in configuration from the transmitting device 5 and the interlocking mechanism 6 of the first embodiment. Further, the projector according to the present embodiment is provided with a support member 123 for supporting the transmitting device 8. Further, the interlocking mechanism 9 of the present embodiment is configured to move (vary the tilt angle) the transmitting device 8 in conjunction with the vertical movement of the first moving section 72 of the lens shift mechanism 7, but not to move the transmitting device 8 in accordance with the movement of the first moving section 72 in the X direction.

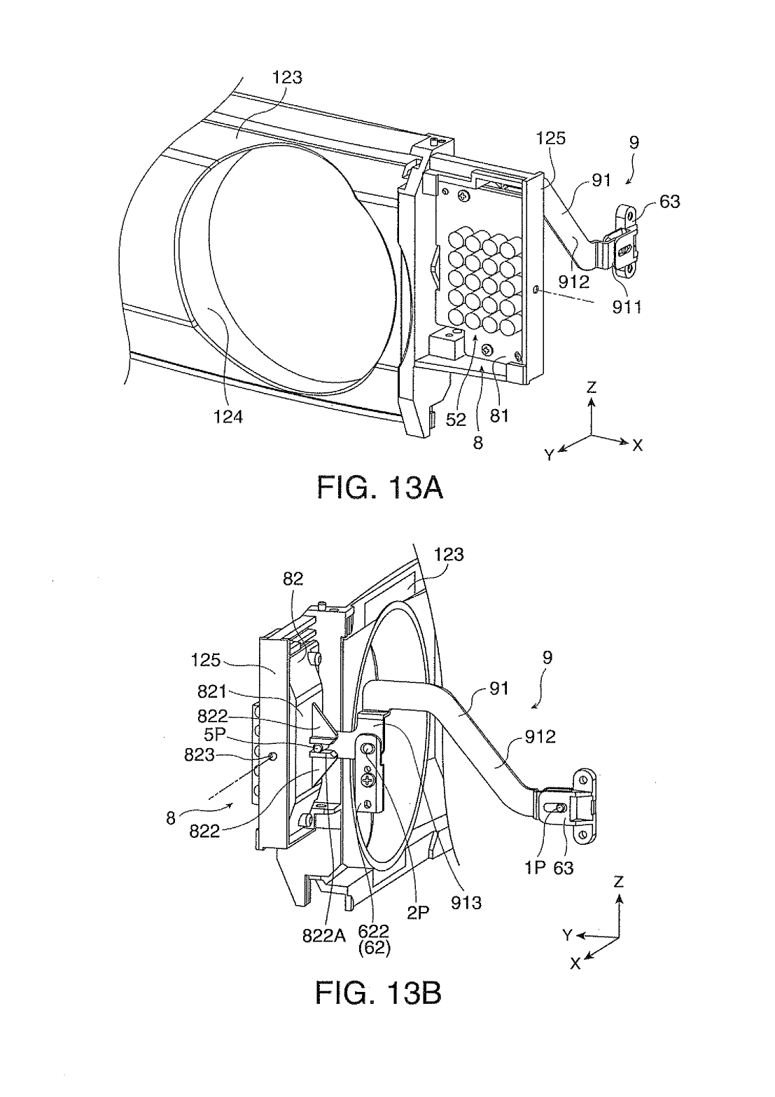

FIGS. 13A and 13B are perspective views showing the support member 123, the transmitting device 8, and the interlocking mechanism 9, wherein FIG. 13A is a diagram thereof viewed obliquely from front, and FIG. 133 is a diagram thereof viewed obliquely from behind.

The support member 123 is provided with a projecting opening section 124 through which the light emitted from the projection lens 36 passes, and on the +X side of the projecting opening section 124, there is disposed a transmitting device support section 125 for rotatably supporting the transmitting device 8.

As shown in FIGS. 13A and 13B, the transmitting device support section 125 is provided with a hole penetrating in the front-back direction and having a rectangular planar shape, and is formed to have a frame-like shape. The transmitting device support section 125 is provided with a bearing penetrating in the X direction formed through each of the +X-side wall section and the −X-side wall section.

As shown in FIGS. 13A and 13B, the transmitting device 8 is provided with a circuit board 81, a plurality of light emitting sections 52, and a board holding section 82.

As shown in FIG. 13A, the circuit board 81 is formed to have a rectangular planar shape. Similarly to the first embodiment, the plurality of light emitting sections 52 is mounted on the front (+Y side) surface of the circuit board 81 so as to output the optical signal 5S frontward (in the +Y direction). Further, the plurality of light emitting sections 52 is disposed so as to be aligned in vertical and horizontal directions viewed from front.

The board holding section 82 is made of synthetic resin, and is formed to hold the circuit board 81 from behind. The board holding section 82 has a frame section 821, a pair of pin guide sections 822, and a pair of shaft sections 823 (one of the shaft sections 823 is not shown).

The frame section 821 is formed so as to cover the surface on the opposite side to the mounting surface of the circuit board 81, and the circuit board 81 is positioned by the frame section 821, and is fixed with screws.

The pair of pin guide sections 822 protrude from the rear center portion of the frame section 821 so as to have a predetermined distance therebetween in the vertical direction. The two surfaces (guide surfaces 822A) of the pair of pin guide sections 822 opposed to each other are each formed to be a flat surface.

The pair of shaft sections 823 respectively protrude from the +X side and the −X side of the frame section 821, and are each formed to have a columnar shape centered on a rotational axis along the X direction.

The transmitting device 8 is rotatably supported by the support member 123 with the pair of shaft sections 823 inserted in the bearings of the transmitting device support section 125.

The interlocking mechanism 9 has a configuration obtained by eliminating the transmitting device guide section 64 and the transmitting device holding section 65 (see FIG. 5) from the interlocking mechanism 6 of the first embodiment. The interlocking mechanism 9 is provided with a connecting lever 91 different in shape from the connecting lever 61 of the first embodiment in addition to the lever support section 62 and the shift-side support section 63 (see FIG. 6) common to the interlocking mechanism 6 of the first embodiment.

As shown in FIGS. 13A and 13B, the connecting lever 91 has a shape obtained by eliminating the transmitting-side connecting section 614 from the connecting lever 61 of the first embodiment. Specifically, the connecting lever 91 has a shift-side connecting section 911 disposed on the side of the lens shift mechanism 7 (see FIGS. 3A and 3B). The connecting lever 91 further includes an arm section 912 and a base section 913 formed in sequence from the end portion of the shift-side connecting section 911 via a bend section.

Further, similar to the connecting lever 61 of the first embodiment, the shift-side connecting section 911 of the connecting lever 91 is provided with the connecting pin 1P, and the base section 913 thereof is provided with the guide pin 2P.

Further, in the vicinity of the front end portion of the base section 913, there is provided an action pin 5P having a columnar shape and protruding in the +X direction. As shown in FIG. 13B, the action pin 5P is inserted between the pair of pin guide sections 822 of the board holding section 82 behind the shaft sections 823.

Here, although not shown in the drawings, an operation of the interlocking mechanism 9 will be explained.

Similarly to the connecting lever 61 of the first embodiment, when the projection lens 36 is moved in the vertical direction, the connecting lever 91 rotates clockwise or counterclockwise viewed from the +X direction. Then, it results that the action pin 5P moves up and down in accordance with the rotation of the connecting lever 91.

When the action pin 5P inserted in the pin guide section 822 moves up and down, the board holding section 82 rotates around the shaft section 823. Then, the transmitting device 8 held by the board holding section 82 rotates in the opposite direction to the rotational direction of the connecting lever 91 together with the board holding section 82 to thereby vary the tilt angle with respect to the optical axis 36C.

On the other hand, similarly to the connecting lever 61 of the first embodiment, when the projection lens 36 is moved in the X direction, the connecting lever 91 rotates clockwise or counterclockwise viewed from above. Then, it results that the action pin 5P moves in the +X direction or the −X direction in accordance with the rotation of the connecting lever 91. Since the action pin 5P does not engage with the board holding section 82 in the X direction, it results that the action pin SP slides on the guide surface 822A of the board holding section 82 in the X direction. Therefore, the transmitting device 8 held by the board holding section 82 does not move (rotate), and the tilt angle with respect to the optical axis 36C is not varied.

As described above, the interlocking mechanism 9 of the second embodiment is configured to move (vary the tilt angle of) the transmitting device 8 in conjunction with the lens shift mechanism 7 only in the vertical direction out of the two directions, namely the vertical direction and the X direction.

As explained above, according to the projector of the present embodiment, the following advantage can be obtained in addition to the advantages 1 through 3, 5, and 6 in the first embodiment.

The interlocking mechanism 9 is configured to move the transmitting device 8 in conjunction with the lens shift mechanism 7 only in the vertical direction out of the two directions, namely the vertical direction and the X direction. Thus, it becomes possible to configure the interlocking mechanism 9 with a structure simpler than that of the interlocking mechanism 6 of the first embodiment interlocking in the two direction, and to reliably reflect the optical signal 5S with the screen SC in conjunction with the movement of the projection lens 36 in the vertical direction, which is thought to be used with high frequency, to thereby make the optical signal 5S reach the image observing spectacles 10 worn by the observer.

### Modified Examples

It should be noted that the embodiments described above can be modified as follows.

It is also possible to configure the lens shift mechanism so that the projection lens 36 can be moved in just one direction (e.g., the vertical direction), and to configure the interlocking mechanism of moving the transmitting device in conjunction with the lens shift mechanism.

Although in the embodiments described above the interlocking mechanisms 6, 9 move the transmitting devices 5, 8 so that the tilt angle with respect to the optical axis 36C varies, it is also possible to have a configuration in which the transmitting device 5, 8 moves in a sliding manner.

Although the lens shift mechanism 7 of the embodiments is configured using a manual mechanism, the lens shift mechanism 7 can also be configured using an electrically-powered mechanism provided with an electric motor or the like.

Although the interlocking mechanism 9 of the second embodiment is configured so as to move the transmitting device 8 in conjunction with the lens shift mechanism 7 in the vertical direction out of the two directions, namely the vertical direction and the X direction, it is also possible to adopt the configuration of moving the transmitting device 8 in conjunction with the lens shift mechanism 7 in the X direction out of the two directions.

Although the projector 1 according to the embodiments described above is configured so as to be able to project the right-eye image as a first image and the left-eye image as a second image on the screen SC in a time-sharing manner, it is also possible to configure so as to be able to project the first and second images different in content from each other on the screen SC in a time-sharing manner besides the right-eye image and the left-eye image. Further, although the image observing spectacles 10 according to the embodiments described above is configured so as to be able to perform the switching between the open state and the light blocking state alternately on the right and left liquid crystal shutters 11R, 11L, it is also possible to configure that both of the right and left liquid crystal shutters 11R, 11L are set to the open state or the light blocking state together with each other. Further, it is also possible to configure the image display system 100 provided with this projector 1 and a plurality of image observing spectacles 10 different from each other in the switching timing to the open state corresponding to the optical signal. Thus, it becomes possible to make a plurality of observers wearing the image observing spectacles 10 different from each other in the timing of switching to the open state respectively observe the images projected on the screen SC as the first image and the second image.

Although the interlocking mechanism 6 of the embodiment described above is configured to move the transmitting device 5 so that the optical signal 5S output from the transmitting device 5 reaches the inside of the image projected on the screen SC, outside of the image projected is also acceptable as long as the interlocking mechanism 6 is configured so that the optical signal 55 reaches the surface of the screen SC.

Although the right and left shutters provided to the image observing spectacles 10 according to the embodiments are configured using the liquid crystal panels, the shutters are not limited to this configuration, and it is also possible to configure the spectacles using shutters of other types.

Although in the projector 1 according to the embodiments described above the transmissive liquid crystal light valve 351 is used as the light modulation device, those using the reflective liquid crystal light valves can also be adopted.

The light source 311 is not limited to the discharge lamp, but can also be configured using a solid-state light source such as a lamp of other types or a light emitting diode.

The entire disclosure of Japanese Patent Application No. 2011-052618, filed Mar. 10, 2011 is expressly incorporated by reference herein.

What is claimed is:

1. A projector adapted to modulate a light beam, which is emitted from a light source, in accordance with image information, and project the light modulated on a screen with a projection lens, the projector comprising:
a lens shift mechanism adapted to move the projection lens in a direction perpendicular to an optical axis of the projection lens;
a transmitting device adapted to output an optical signal different from the light toward the screen; and
an interlocking mechanism adapted to move the transmitting device in conjunction with movement of the projection lens due to the lens shift mechanism.

2. The projector according to claim 1, wherein
the interlocking mechanism moves the transmitting device so that a location of the optical signal varies in conjunction with movement of an image projected on the screen due to the lens shift mechanism.

3. The projector according to claim 2, wherein
the interlocking mechanism moves the transmitting device so that the optical signal output from the transmitting device is emitted within the image moved on the screen by the lens shift mechanism.

4. The projector according to claim 1, wherein
the lens shift mechanism is configured to be able to move the projection lens in a predetermined direction in a plane perpendicular to the optical axis, and
the interlocking mechanism moves the transmitting device so that the direction of the output of the optical signal is changed to the predetermined direction in conjunction with movement of the projection lens toward the predetermined direction.

5. The projector according to claim 1, wherein
the lens shift mechanism is configured to be able to move the projection lens in two directions perpendicular to each other in a plane perpendicular to the optical axis, and
the interlocking mechanism moves the transmitting device so that the direction of the optical signal output from the transmitting device is changed in conjunction with movement of the projection lens in one of the directions.

6. The projector according to claim 1, wherein
the lens shift mechanism is configured to be able to move the projection lens in two directions perpendicular to each other in a plane perpendicular to the optical axis, and
the interlocking mechanism moves the transmitting device so that the direction of the output of the optical signal is changed to the two directions in conjunction with movement of the projection lens toward the two directions, respectively.

7. The projector according to claim 1, wherein
the projector is configured to be able to project a first image and a second image on the screen in a time-sharing manner, and
the optical signal is an optical signal synchronous with switching between the first image and the second image.

8. The projector according to claim 7, wherein
the first image is a right-eye image and the second image is a left-eye image.

9. An image display system comprising:
the projector according to claim 7; and
an image observing spectacles including a receiving section adapted to receive the optical signal output from the transmitting device and reflected by the screen, and a shutter switched in accordance with the optical signal received by the receiving section between an open state in which a light passes through the shutter and a light blocking state in which the light is blocked by the shutter.
